(19) United States
(12) Patent Application Publication
(10) Pub. No.: US 2006/0214341 A1
(43) Pub. Date: Sep. 28, 2006

(54) Vibration damping rubber bushing

(75) Inventors: Takanori Sugiura, Komaki-shi (JP); Takehiko Taguchi, Komaki-shi (JP); Amane Hoshi, Aichi-ken (JP); Akira Matsuda, Inuyama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: TOKAI RUBBER INDUSTRIES, LTD., Komaki-shi (JP); DAI NIPPON TOKYO CO., LTD., Osaka-shi (JP)

(21) Appl. No.: 11/385,654

(22) Filed: Mar. 22, 2006

(30) Foreign Application Priority Data
Mar. 23, 2005 (JP) 2005-084266

(51) Int. Cl. F16F 1/44

(52) U.S. Cl. 267/293

(57) ABSTRACT

A vibration damping rubber bushing that has excellent vibration damping property and anticorrosive property, can strongly fix to a supporting component, and has excellent fall off-preventing property in using the same. The vibration damping rubber bushing includes an inner sleeve, an outer sleeve, and a rubber elastic body interposed between the inner sleeve and the outer sleeve, the inner sleeve, outer sleeve and rubber elastic body being integrally formed, wherein a coating film of an aqueous paint including an amino-modified epoxy resin as a binder is formed on a circumference of at least the outer sleeve selected from the inner sleeve and the outer sleeve.

### BACKGROUND OF THE INVENTION

1. Field of the Invention

The present invention relates to a vibration damping rubber bushing that can widely be utilized in vehicles, particularly an automotive vehicle.

2. Description of the Art

Conventionally, for the purpose of elastically connecting two components, thereby reducing vibration and/or noises, it has widely been carried out to interpose a vibration damping rubber bushing between the two components. In particular, reduction in vibration and/or noises is indispensable to vehicles such as an automotive vehicle. For this reason, a demand for such a vibration damping rubber bushing is high, and for example, various vibration damping rubber bushings such as a suspension bushing and a stabilizer bushing are already used in this field. In general, the vibration damping rubber bushing has a structure such that an inner sleeve and an outer sleeve that are concentrically or eccentrically arranged, are integrally formed through a rubber elastic body interposed therebetween by vulcanization adhering. The outer sleeve side of the rubber bushing is fixed to one component (a supporting component) such as a suspension arm, and the inner sleeve side thereof is fixed to the other component. As a result, the vibration damping rubber bushing exhibits its vibration damping performance between those two components.

A coating film including an anticorrosive paint is generally formed on a circumference of the vibration damping rubber bushing (particularly, a surface of the sleeve portion) Organic solvent-type paints have conventionally been sometimes used as the anticorrosive paint. However, this has involved some apprehensions on influence to the rubber, increase of load to the environment, and the like. For this reason, it is recently proposed to use various aqueous paints to form a coating film on the circumference of the vibration damping rubber bushing, as described in, for example, Japanese Unexamined Patent Publication No. 2002-317844.

Fixing the rubber bushing to the supporting component such as a suspension arm is carried out by press inserting the rubber bushing in a holding hole provided on the supporting component. In this regard, it is important for the press insertion of the rubber bushing that press insertion is easily conducted, and the rubber bushing is strongly fixed to the supporting component, that is, the rubber bushing is difficult to be fallen off from the supporting component. To achieve this requirement, it is necessary to impart the performance capable of answering such a requirement to a coating film of the circumference of the rubber bushing, particularly, a coating film formed on a press insertion area (circumference of the outer sleeve in the rubber bushing) toward the holding hole of the supporting component.

For example, the technology disclosed in the above-described Japanese Patent Publication No. 2002-317844 attempts to improve insertion property of the rubber bushing into the supporting component (good smoothness at press inserting) by containing fluororesin particles or the like in the coating film. However, the countermeasure to the problems, such as suppression of a fall off load, is not taken. Further, where a thermosetting paint is used, such a paint is poor in safety, and also requires heating in conducting a curing reaction thereof, which may involve the possibility of deterioration of the rubber. Thus, there is the problem in using such a paint. A technology of forming a coating film with an aqueous paint and obtaining an anticorrosive property by such a coating film is proposed. However, the coating film formed from such an aqueous paint generally has low film hardness, and this tendency is remarkable in a room temperature-drying paint. Thus, it is the present status that the conventional technologies cannot immediately overcome the above-described problems. Even in the use of the aqueous paint conventionally used in this field, it was possible to increase hardness of a coating film thereof by, for example, baking. However, in such a case, the rubber deteriorates due to heating, and thus there is the problem to simply conduct baking.

### SUMMARY OF THE INVENTION

The present invention has been made in view of the above circumstances.

Accordingly, an object of the invention is to provide a vibration damping rubber bushing that has excellent vibration damping property and anticorrosive property, can strongly fix to a supporting component, and has excellent fall off-preventing property in using the same.

To achieve the above object, the vibration damping rubber bushing according to the invention includes an inner sleeve, an outer sleeve, and a rubber elastic body interposed between the inner sleeve and the outer sleeve, the inner sleeve, outer sleeve and rubber elastic body being integrally formed, wherein a coating film of an aqueous paint including an amino-modified epoxy resin as a binder is formed on a circumference of at least the outer sleeve selected from the inner sleeve and the outer sleeve.

To overcome the above-described problems in the art, the investigations were made for the purpose of forming an anticorrosive coating film capable of answering the above-described requirement on a press insertion area of a vibration damping rubber bushing (a circumference of an outer sleeve) toward a holding hole of a supporting component such as a suspension arm, and were further made regarding a room temperature-drying aqueous paint for forming such a coating film. However, in view of the fact that it is difficult to obtain the desired hardness by room temperature drying in the general aqueous paints as described above, investigations were further continued. As a result, it has been found that when the coating film is formed using an aqueous paint including an amino-modified epoxy resin as a binder, an anticorrosive coating film having high hardness can be formed at room temperature without deterioration of a rubber, whereby the desired object can be achieved. The invention has been accomplished based on this finding.

As described above, the vibration damping rubber bushing according to the invention has a coating film of an aqueous paint including an amino-modified epoxy resin as a binder, formed on a circumference of at least the outer sleeve. Due to this constitution, a disadvantage such as breakage of a coating film by insertion pressure does not occur in using the rubber bushing by press insertion, and the rubber bushing can strongly be fixed to (difficult to fall off from) the supporting component. Further, heating is not required in forming the coating film, and as a result, deterioration of a rubber does not cause. Therefore, the rubber bushing has excellent vibration damping performance.

### BRIEF DESCRIPTION OF THE DRAWING

FIG. 1 is a sectional view showing one example of the vibration damping rubber bushing according to the invention.

FIG. 2 is a sectional explanatory view showing one example of a fixing embodiment of the vibration damping rubber bushing according to the invention.

### DETAILED DESCRIPTION OF THE INVENTION

The present invention is described in detail below.

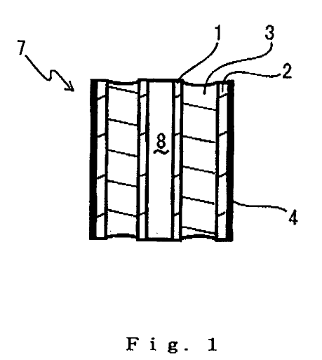

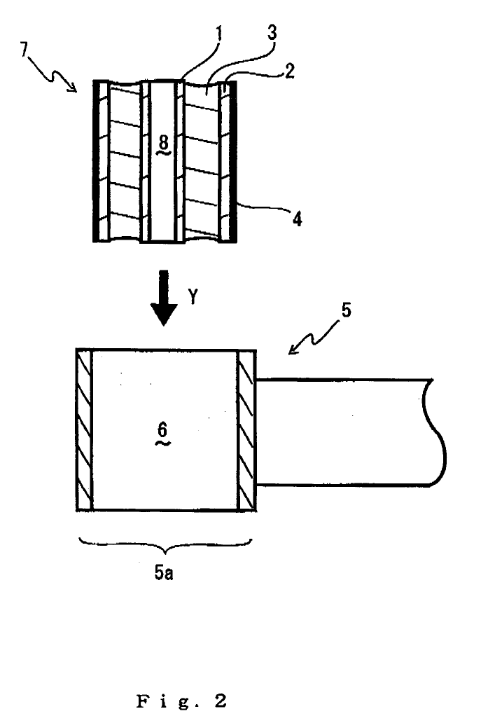

As one embodiment, a vibration damping rubber bushing 7 of the invention is a structure that a rubber elastic body 3 is interposed between an inner sleeve 1 and an outer sleeve 2, and those are integrally formed through vulcanization adhering or the like, as shown in the sectional view of FIG. 1. A circumference of the outer sleeve 2 is provided with an anticorrosive coating film 4 formed by an aqueous paint including an amino-modified epoxy resin as a binder. FIG. 2 is one example of a fixing embodiment of the vibration damping rubber bushing in a suspension arm. In FIG. 2, 5 is a suspension arm which is one supporting component, and a cylindrical holding hole 6 is provided at an end 5a of the suspension arm. The vibration damping rubber bushing 7 of the invention is press inserted in the holding hole 6 (direction of an arrow head Y). A shaft component (not shown) as the other supporting component is inserted through a hole portion 8 inside the inner sleeve 1 of the vibration damping rubber bushing 7, and fitted thereto, followed by putting into practical use. By this configuration, vibration damping performance of the vibration damping rubber bushing 7 is exhibited, and at the same time, the vibration damping rubber busing 7 is strongly fixed to the suspension arm 5 by the action of the specific anticorrosive coating film 4 provided on the vibration damping rubber bushing 7. This enables the vibration damping rubber bushing 7 to be difficult to be fallen off from the suspension arm 5. If desired and necessary, the anticorrosive coating film 4 may be formed on not only the circumference of the outer sleeve 2, but inner surface thereof. In addition to this, the coating film may similarly be formed on the inner surface of the inner sleeve 1.

In the vibration damping rubber bushing 7, the inner sleeve 1 and the outer sleeve 2 are not particularly limited so long as those are made of a metal. For example, sleeves formed from the conventional metals such as iron, copper, aluminum, magnesium, zinc, tin or their alloys, and stainless steel are used. In those sleeves, a primer treatment may appropriately be applied to the interface between the rubber elastic body 3 and each sleeve.

In a rubber composition forming the rubber elastic body 3, a rubber such as a natural rubber (NR), a styrene-butadiene rubber (SBR), a butadiene rubber (BR), an isoprene rubber (IR), a chloroprene rubber (CR), an ethylene-propylene terpolymer (EPDM) or a silicone rubber is used as its polymer material. The rubber composition can contain, in addition to the rubber, various additives such as a filler (such as carbon black or silica), a vulcanizing agent (such as sulfur), a vulcanization accelerator, a vulcanization assistant (such as zinc oxide or magnesium oxide), an antioxidant, a processing aid (such as stearic acid, fatty acid ester or fatty acid amide), and a softener (such as a process oil). The rubber composition can be prepared by kneading the respective components with a closed type kneading machine (Banbury type), a roll, a twin-screw kneading extruder, or the like.

In the vibration damping rubber bushing 7, the anticorrosive coating film 4 of an aqueous paint including an amino-modified epoxy resin as a binder is formed on the circumference of the outer sleeve 2. Specifically, to make the vibration damping rubber bushing 7 be difficult to be fallen off from the suspension arm 5 as the supporting component, it is necessary to provide the coating film 4 on the circumference of the outer sleeve 2, which is the press insertion area toward the supporting component. The anticorrosive coating film 4 may be formed on the inner surface of the inner sleeve 1 as described before other than the circumference of the outer sleeve 2. Further, the coating film may be formed such that the whole vibration damping rubber bushing 7 is covered therewith.

The aqueous paint including an amino-modified epoxy resin as a binder is used as the material for forming the anticorrosive coating film 4 as described above. It is required for the coating film 4 formed from the aqueous paint to have the desired hardness, namely, hardness in an extent of a pencil hardness H, by room temperature curing. The “room temperature” used herein means a temperature in a range of from 10 to 40° C. The amino-modified epoxy resin used in the aqueous paint can be prepared by, for example, ring-opening an epoxy ring possessed by the epoxy resin as a starting material by a reaction with primary amines, secondary amines, tertiary amines or their acid salts. An example of the epoxy resin used in the invention includes polyphenol polyglycidyl ether type epoxy resins that are reaction products of polycyclic phenol compounds (such as bisphenol A, bisphenol F, bisphenol S, phenol-novolak or cresol-novolak) with epichlorohydrin. Further, oxazolidone ring-containing epoxy resins obtained by the reaction of a diisocyanate compound and epichlorohydrin can be used.

The epoxy resin can be used by chain extending with, for example, bifunctional polyester polyols, polyether polyols or bisphenols, or dibasic carboxylic acids prior to ring-opening reaction of the epoxy ring with amines or amine acid salts. Further, the epoxy resin can be used by adding a monohydroxyl compound (such as 2-ethyl hexanol, nonyl phenol, ethylene glycol mono-2-ethylhexyl ether, or propylene glycol mono-2-ethylhexyl ether) to a part of the epoxy ring for the purpose of, for example, controlling a molecular weight or an amine equivalent, or improving heat flow property.

Examples of the amines that can be used in ring opening the epoxy ring and introducing an amino group include primary, secondary or tertiary amines, such as butyl amine, octyl amine, diethyl amine, dibutyl amine, methyl butyl amine, monoethanol amine, diethanol amine, N-methyl ethanol amine, triethyl amine acid salt and N,N-dimethyl ethanol amine; and their acid salts. Further, ketimine-blocked primary amino group-containing secondary amines such as aminoethyl ethanol amine methyl isobutyl ketimine can be used.

The epoxy resin has a number average molecular weight in a range of preferably from 600 to 10,000 Where the number average molecular weight is less than 600, physical properties such as solvent resistance and corrosion resistance of the coating film obtained tend to be poor, and on the other hand, where it exceeds 10,000, productivity of a paint and coating workability tend to decrease due to rise of viscosity of the paint. The epoxy resin has an amino value in a range of preferably from 30 to 150 KOH mg/g, and more preferably from 45 to 120 KOH mg/g. Where the amino value is less than 30 KOH mg/g, stability of the paint tends to decrease, and on the other than hand, where it exceeds 150 KOH mg/g, there is the possibility of causing the problem on coating workability.

The amino-modified epoxy resin that can preferably be used is a water dispersion type epoxy resin. The water dispersion type epoxy resin can be prepared by the conventional methods such as an emulsion polymerization method, a forced emulsion method and self-emulsion method.

The content of the entire binder in the above specific aqueous paint is set in a range of preferably from 10 to 40% by weight, and more preferably from 15 to 30% by weight, based on the weight of the specific aqueous paint.

The aqueous paint used in the vibration damping rubber bushing 7 of the invention contains the amino-modified epoxy resin as a binder. Depending on the performance required of the resulting coating film, other resin can be used as a binder in combination with the amino-modified epoxy resin. Examples of the other resin that can be used in combination include an acrylic resin, a urethane resin, an epoxy resin and an inorganic resin. Where the other resin is used in combination, the other resin is added in an amount of preferably 30% by weight or less based on the weight of the entire binder. The reason for this is that by suppressing the addition amount of the other resin to this range, it is possible to form a coating film satisfying the desired requirement performance without impairing the object of the invention.

The specific aqueous paint contains water as a main dilutent. A film-forming assistant can be added to the paint to improve drying property of the paint. Examples of the film-forming assistant include benzyl alcohol, 2,2,4-trimethyl-1,3-pentanediol monoisobutyrate, ethylene glycol monobutyl ether, diethylene glycol monobutyl ether, triethylene glycol monobutyl ether, diethylene glycol dibutyl ether, dipropylene glycol monomethyl ether, diethylene glycol monobutyl ether acetate, ethylene glycol mono-2-ethylhexyl ether, diethylene glycol mono-2-ethylhexyl ether, propylene glycol monobutyl ether, dipropylene glycol monobutyl ether, and dipropylene glycol dimethyl ether. Those are used alone or as mixtures of two or more thereof. The film-forming assistant can be used in an amount of 10% by weight or less based on the weight of a resin solid content as a binder in the aqueous paint. Where the amount of the film-forming assistant exceeds 10% by weight, there is the tendency to cause the problems of unfavorable odor when coating, and decrease in storage stability of the aqueous paint.

The specific aqueous paint generally contains an anticorrosive pigment. Examples of the anticorrosive pigment include zinc phosphate, iron phosphate, aluminum phosphate, calcium phosphate, zinc phosphite, zinc cyanite, zinc oxide, aluminum tripolyphosphate, a dihydrogen tripolyphosphate-based pigment, and a dibasic phosphate-based pigment. Preferably contained are zinc phosphate, a dihydrogen tripolyphosphate-based pigment and a dibasic phosphate-based pigment. To improve an anticorrosive property of the coating film formed, it is effective to further use zinc white in an amount within the range of the anticorrosive pigment added.

The amount of the anticorrosive pigment added is preferably from 3 to 20% by weight, and more preferably from 5 to 10% by weight, based on the weight of the specific aqueous paint. Where the amount of anticorrosive pigment added is less than 3% by weight, an anticorrosive effect decreases, and on the other hand, where the amount exceeds 20% by weight, it is difficult to disperse the anticorrosive pigment in the specific aqueous paint, and there is the possibility causing coagulation and/or precipitation.

A coloring pigment, an extender pigment and the like can further be contained as a pigment component in the specific aqueous paint. The coloring pigment is a component for imparting a given color to the aqueous paint, and examples thereof include carbon black, titanium white, lead white, and red oxide. The extender pigment is a component for imparting necessary properties to the aqueous paint, and examples thereof include kaolin, antimony oxide, zinc oxide, basic lead carbonate, basic zinc sulfate, barium carbonate, calcium carbonate, silica alumina, magnesium carbonate, magnesium silica, and talc. Other than those, for example, silicon oxide fine particle pigment such as hydrophilic silicon dioxide may further appropriately be added.

The specific aqueous paint may appropriately contain a tin-based accelerator compound as a hardening accelerator. Examples of the tin-based accelerator compound include dibutyltin dilaurate, dioctyltin maleate, and dibutyltin oxide.

The specific aqueous paint may further contain a neutralization acid for water dispersing or water solubilizing the above respective components. Examples of the neutralization acid include formic acid, acetic acid, lactic acid, propionic acid, boric acid, butyric acid, dimethylolpropionic acid, hydrochloric acid, sulfuric acid, phosphoric acid, N-acetylglycine, and N-acetyl-p-alanine. The amount of the acid added varies depending on the amount of amino groups in the epoxy resin, and may be sufficient if it is an amount that can stably water disperse or water solubilize the components.

The specific aqueous paint may further contain conventional additives for paint, such as a dispersing agent, a defoaming agent, a thickener, a pH adjustor, a thixotropic agent, a plasticizer, a surfactant, an antioxidant, and a UV absorber.

A method of producing the specific aqueous paint is not particularly limited, and is carried out by, for example, kneading the respective components with a ball mill, a kneader, a roll or the like, and dispersing the resulting mixture in water (ion-exchanged water).

A method of producing the vibration damping rubber bushing 7 of the invention is not particularly limited, and for example, the rubber bushing can be produced as follows.

The inner sleeve 1, the outer sleeve 2 and the given rubber composition are provided. Using those, a rubber bushing having a structure shown in FIG. 1 is prepared. In this case, a rubber elastic body 3 is formed from the rubber composition as follows. The inner sleeve 1 and the outer sleeve 2 are arranged in a mold as shown in FIG. 1, and the rubber composition is then filled so as to interpose the same between the inner sleeve 1 and the outer sleeve 2. The rubber composition is then vulcanized. Alternatively, the rubber composition is previously vulcanization molded into a given shape using a mold or the like, and the vulcanized rubber is interposed between the inner sleeve 1 and the outer sleeve 2. In general, after forming the assembly, the outer sleeve 2 is appropriately subjected to squeezing processing to reduce the diameter thereof, whereby the rubber elastic body 3 interposed between the inner sleeve 1 and the outer sleeve 2 is compressed and fixed thereto. In the rubber bushing thus formed, the circumference of at least the outer sleeve 2 is coated with the specific aqueous paint. In this case, the coating method is not particularly limited, and can use the conventional methods such as a dipping method, a spray coating method, and a roll coating method. After coating, a room temperature drying (drying at a temperature of from 10 to 40° C. for from about 1 to 24 hours) is conducted to remove a solvent (water, a film-forming assistant or the like) in the aqueous paint by evaporation, thereby forming a specific anticorrosive coating film 4. Thus, the desired vibration damping rubber bushing 7 can be prepared.

In the vibration damping rubber bushing 7 thus obtained, the anticorrosive coating film 4 has a dry thickness of preferably from 10 to 40 μm, and more preferably from 15 to 30 μm. Where the dry thickness of the anticorrosive coating film 4 is less than 10 μm, it is difficult to secure the anticorrosive performance, on the other hand, where it exceeds 40 μm, it is difficult to secure the fall off-preventing property (suppression of a fall off load) and further a disadvantage of insertion of the rubber bushing into a suspension arm or the like as a supporting component is liable to occur.

The vibration damping rubber bushing 7 is fixed to the suspension arm 5 as the supporting component as shown in FIG. 2. A shaft component (not shown) as the other supporting component is inserted in the hole portion 8 inside the inner sleeve 1 of the vibration damping rubber bushing 7 to fix thereto, and such an assembly is put into practical use.

The suspension arm 5 shown above is only one example of the supporting component to the vibration damping rubber bushing of the invention, and the fixing embodiment shown in FIG. 2 is also one practical embodiment of the vibration damping rubber bushing of the invention. Therefore, the use of the vibration damping rubber bushing of the invention is not particularly limited. However, the vibration damping rubber bushing of the invention is preferably used as a rubber bushing of vehicles such as an automotive vehicle. Specifically, the vibration damping rubber bushing of the invention can preferably be used in, for example, a stabilizer bushing, a tension rod bushing, a lowering bushing, an arm bushing, a member mount, a strut mount, an engine mount, a body mount, a carburetor mount, a strut bar cushion, a center bearing support, a torsional damper, a steering rubber coupling, a bumper strapper, an FF engine roll stopper, or a muffler hanger.

The present invention is described in more detail by reference to the following Example and Comparative Example.

### EXAMPLE

The following aqueous paint and vibration damping rubber bushing were provided and prepared, and the desired vibration damping rubber bushing was prepared by conducting the coating described below.

Aqueous Paint for Forming Anticorrosive Coating Film

Aqueous epoxy resin paint (TMA Super Black, a product of Dai Nippon Toryo Co.)

Composition of TMA Superblack:

Emulsion varnish of amino-modified epoxy resin: 48 wt % (solid content 40 wt %)

Pigment: 21.0 wt %

Additives (dispersing agent, defoaming agent, thickener, pH adjustor, film-forming assistant, and thixotropic agent): 6.8 wt %

Ion-exchanged water: 24.2 wt %

Production of Vibration Damping Rubber Bushing

100 parts by weight (hereinafter simply referred to as “part”) of natural rubber, 1 part of stearic acid, 5 parts of zinc oxide, 50 parts of FEF (Fast Extruding Furnace) carbon black, 10 parts of a process oil, 1.5 parts of TMDQ (polymerized 2,2,4-trimethyl-1,2-dihydroquinoline) as an antioxidant, 1.5 parts of CBS (N-cyclohexyl-2-benzothiazylsulfenamide) as a vulcanization accelerator, and 2 parts of sulfur were provided, and those were mixed under stirring to prepare a rubber composition. An inner sleeve made of iron (inner diameter: 12.4 mm, and wall thickness: 5.3 mm) and an outer sleeve made of iron (inner diameter: 53.0 mm, and wall thickness: 2.3 mm) were provided. Those sleeves were arranged concentrically in a mold, and the rubber composition prepared above was filled in a space between the inner sleeve 1 and the outer sleeve 2, followed by vulcanization. Thus, a vibration damping rubber bushing (semi-finished product) was prepared.

Coating

The aqueous paint was applied by dipping to the circumference of the outer sleeve of the rubber bushing. The resulting coating was dried at 40° C. for 24 hours to form an anticorrosive coating film (thickness: 20 μm). Thus, the desired vibration damping rubber bushing was produced (see FIG. 1).

### COMPARATIVE EXAMPLE

A commercially available bisphenol A type aqueous epoxy resin paint (Emulon Super TR Black, a product of Dai-Nippon Toryo Co.) was provided. The desired vibration damping rubber bushing was produced in the same manner as in the Example, except for using the commercially available paint in place of the aqueous paint of the Example.

Using the vibration damping rubber bushings obtained in the Example and the Comparative Example, the characteristics thereof were evaluated according to the following criteria.

The results obtained are shown in the Table below.

Hardness of Coating Film

Hardness (pencil hardness) of the anticorrosive coating film was measured according to JIS K5400.

Fall Off-Preventing Property

A suspension arm having formed therein a cylindrical holding hole having an inner diameter of 55 cm was provided, and the vibration damping rubber bushing was incorporated into the holding hole (see FIG. 2), and fall off-preventing property of the vibration damping rubber bushing was evaluated. Specifically, when a fall off-force was applied to the vibration damping rubber bushing with a load of 20,000N, the case that the vibration damping rubber bushing was fallen off from the suspension arm was evaluated “Poor”, and the case of not falling off was evaluated “Good”.

TABLE

| | | Comparative |
|---|---|---|
| | Example | Example |
| Hardness (pencil | H | B |
| hardness) of coating film | | |
| Fall off-preventing | Good | Poor |
| property | | |

As is apparent from the above results, the product obtained in the Example has excellent fall off-preventing property. Therefore, such a product is effective for use in a vibration damping rubber bushing of vehicles such as an automotive vehicle. On the other hand, the product obtained in the Comparative Example has the possibility of falling off. Therefore, there is the problem in using such a product as a vibration damping rubber bushing of vehicles such as an automotive vehicle.

The vibration damping rubber bushing according to the invention is effective to elastically connect two components, thereby reducing vibration and/or noises, and therefore can widely be used in various fields. Of those use fields, the vibration damping rubber bushing of the invention is suitably used in various rubber bushings for an automotive vehicle, such as a suspension bushing and a stabilizer bushing used in vehicles such as an automotive vehicle.

What is claimed is:

1. A vibration damping rubber bushing comprising an inner sleeve, an outer sleeve, and a rubber elastic body interposed between the inner sleeve and the outer sleeve, the inner sleeve, outer sleeve and rubber elastic body being integrally formed, wherein a coating film of an aqueous paint comprising an amino-modified epoxy resin as a binder is formed on a circumference of at least the outer sleeve selected from the inner sleeve and the outer sleeve.
